(19) United States
(12) Patent Application Publication
(10) Pub. No.: US 2013/0337866 A1
(43) Pub. Date: Dec. 19, 2013

(54) SYSTEM AND METHOD FOR EXTERNAL DATA ENTRY AND DISPLAY FOR PORTABLE COMMUNICATION DEVICES

(71) Applicant: Nam Kim, San Diego, CA (US)

(72) Inventor: Nam Kim, San Diego, CA (US)

(21) Appl. No.: 13/527,495

(22) Filed: Jun. 19, 2012

(51) Int. Cl. H04W 4/20

(52) U.S. Cl. 455/557

(57) ABSTRACT

A data display and entry apparatus for a portable communication device is disclosed. The apparatus includes a data entry portion configured to receive a user data entry for use by an application executed outside the apparatus, a display portion configured to display graphics based on data associated with the application, and a data communication interface configured to receive the data associated with the application from a portable communication device and to send user-entered data indicative of the user data entry to the portable communication device using one or more data links.

### FIELD OF THE INVENTION

The present invention generally relates to data entry and display devices and, in particular, relates to system and method for external data entry and display for portable communication devices.

### BACKGROUND

Portable communication devices such as smartphones and tablets are becoming ubiquitous tools for mobile communication. For example, new generation of smartphones such as iPhone, Google Android phone and tablet computers such as iPad and Galaxy Tab are equipped with processors and data storage capabilities that rival those of the conventional laptop computers. Such devices are also equipped with advanced wireless capabilities such as 4G LTE, Wi-Fi and Bluetooth that can provide high-speed data access with Internet and peripheral devices such as digital cameras and printers. They are also equipped with high-resolution touchscreen devices that allow the user to enter data as well as view high-resolution graphics. Using these capabilities, mobile users can make and receive calls, read and write e-mails, browse web pages, download and view documents and run preloaded or downloaded applications.

Despite these advancements, however, the usefulness of the smartphones and tablets to mobile users is limited by the user interface problem associated with portable communication devices. The small size of the touchscreen display limits the capabilities of these devices compared to those of the conventional laptop computers. For example, it is difficult to show multiple windows on the touchscreen display due to its size. It is also difficult to efficiently type text on the touchscreen due to the size of the keyboard. The inability to provide the full data entry and display capability of conventional laptop computers severely limits the usefulness of these portable communication devices for business and other applications that require substantial data entry and display interactions. For this reason, a business traveler or a student often needs to haul a separate laptop computer when he is away from his office or home to work on such applications (e.g., word or spreadsheet applications).

### BRIEF SUMMARY OF THE INVENTION

Various embodiments of the subject disclosure solve these and other problems by providing system and method for external data entry and display for portable communication devices.

In certain aspects, a data entry and display apparatus for a portable communication device is provided. The apparatus comprises a data entry portion configured to receive a user data entry for use by an application executed outside the apparatus. The apparatus can further comprise a display portion configured to display graphics based on data associated with the application. The apparatus can further comprise a data communication interface configured to receive the data associated with the application from a portable communication device and to send user-entered data indicative of the user data entry to the portable communication device using one or more data links.

In certain aspects, the data entry portion can comprise a touchscreen display device. The data entry portion can comprise an image displayed on the touchscreen display device for the user data entry.

In certain aspects, the data entry portion and the display portion can be implemented in two contiguously-joined display devices. At least the data entry portion can be a touchscreen display device.

In certain aspects, the data entry portion and the display portion can be implemented in a single integrated touchscreen display device. The touchscreen display device can comprise an organic light-emitting diode (OLED) device fabricated on a flexible substrate.

In certain aspects, the application can be executed in the portable communication device. The display portion can be configured to display a user interface of the portable communication device. The application can be launched from the user interface display on the display portion. At least one task associated with the application can be executed in an external computer remotely connected to the portable communication device.

In certain aspects, the application can be executed in an external computer remotely connected to the portable communication device. The display portion can be configured to display a remote desktop sent from the external computer. The application can be launched from the remote desk top displayed on the display portion.

In certain aspects, the user-entered data can comprise alphanumeric data. The user-entered data can include data indicative of gestures.

In certain aspects, the data entry and display apparatus can further comprise a processor connected to the data communication interface and a display controller connected to the display portion. The processor can be further configured to receive the data associated with the application from the data communication interface and to provide the data associated with the application to the display controller.

In certain aspects, the data communication interface can be connected to a display controller connected to the display portion. The data communication interface can be further configured to receive graphics data associated with the application from the portable communication device and provide the graphics data to the display controller.

In certain aspects, the one or more data links can comprise a wireless link. The one of more data links can comprise a physical link. The data entry and display apparatus can be powered from the physical link.

In certain aspects, a portable communication device is provided. The portable communication device comprises a first data communication interface configured to provide a first remote data connection with an external computer configured to execute an application. The portable communication device can further comprise a second data communication interface configured to provide a second remote data connection with an external data entry and display apparatus configured to display graphics associated the application and generate user-entered data to be used by the application. The portable communication device can further comprise a processor configured to receive the user-entered data from the apparatus via the second data communication interface and provide the user-entered data to the external computer via the first data communication interface.

In certain aspects, the processor can be further configured to receive data associated with the application from the external computer via the first data communication interface and send graphics data associated with the application to the apparatus via the second data communication interface.

In certain aspects, the graphics data can comprise a remote desktop sent from the external computer.

In certain aspects, a portable communication device is provided. The portable communication device comprises a memory for storing an application. The portable communication device can further comprise a first data communication interface configured to provide a first remote data connection with an external computer configured to execute at least one task associated with the application. The portable communication device can further comprise a second data communication interface configured to provide a second remote data connection with an external data entry and display apparatus configured to display graphics associated with the application and generate user-entered data to be used by the application. The portable communication device can further comprise a processor configured to execute the application and to receive a result of the at least one task executed in the external computer via the first data communication interface and to send data associated with the application to the apparatus via the second data communication interface.

In certain aspects, the processor can be further configured to receive the user-entered data from the apparatus via the second data communication interface and send the user-entered data to the external computer via the first data communication interface.

### BRIEF DESCRIPTION OF SEVERAL VIEWS OF THE DRAWINGS

FIG. 1 is a diagram depicting an exemplary data entry and display apparatus for a portable communication device according certain aspects of the subject disclosure.

FIG. 2 is a diagram depicting an exemplary data entry and display apparatus displaying a QWERTY keyboard and a touchpad.

FIG. 3 is a diagram depicting an exemplary data entry and display apparatus displaying a foreign-language keyboard.

FIG. 4A is a diagram depicting an exemplary integrated data entry and display apparatus according to certain aspects of the subject disclosure.

FIG. 4B is a diagram depicting the exemplary integrated data entry and display apparatus of FIG. 4A displaying a slide presentation.

FIG. 4C is a diagram depicting the exemplary integrated data entry and display apparatus of FIG. 4A displaying a graphics image from a game application.

FIG. 5 is a diagram depicting an exemplary arrangement of a data entry and display apparatus and a portable communication device according to certain aspects of the subject disclosure.

FIG. 6 is a diagram depicting another exemplary arrangement of a data entry and display apparatus and a portable communication device according to certain aspects of the subject disclosure.

FIG. 7 is a diagram depicting another exemplary arrangement of a data entry and display apparatus and a portable communication device according to certain aspects of the subject disclosure.

FIG. 8 is a diagram depicting another exemplary arrangement of a data entry and display apparatus and a portable communication device according to certain aspects of the subject disclosure.

FIG. 9A is a diagram depicting the display portion of the apparatus displaying notification objects for e-mail, voice mail, electronic message and incoming call along with an application.

FIG. 9B is a diagram depicting the display portion of the apparatus displaying multiple windows associated with multiple applications.

FIG. 9C is a diagram depicting the display portion of the apparatus displaying multiple windows associated with multiple application along with the home screen of the portable communication device.

FIG. 10 is a flowchart illustrating an exemplary process for operation of a data entry and display apparatus and a portable communication device according to certain aspects of the subject disclosure.

### DETAILED DESCRIPTION

In the following detailed description, numerous specific details are set forth to provide a full understanding of the subject matter. It will be apparent, however, to one ordinarily skilled in the art that the subject matter may be practiced without some of these specific details. In other instances, well-known structures and techniques have not been shown in detail to avoid unnecessarily obscuring the subject matter.

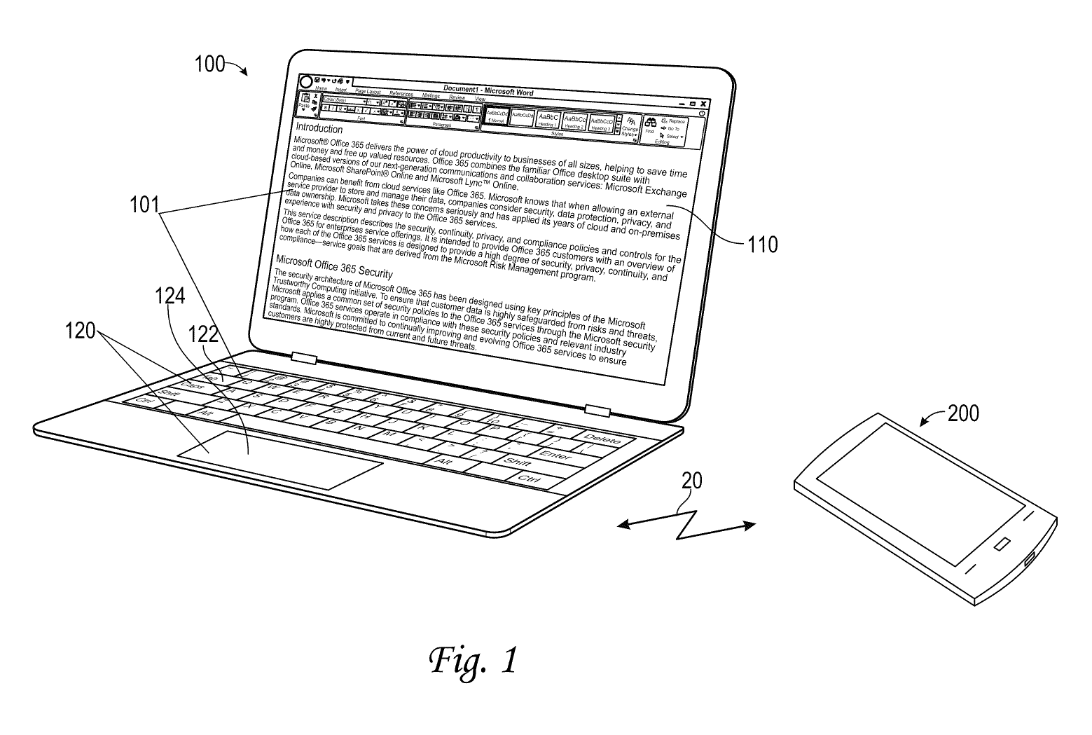

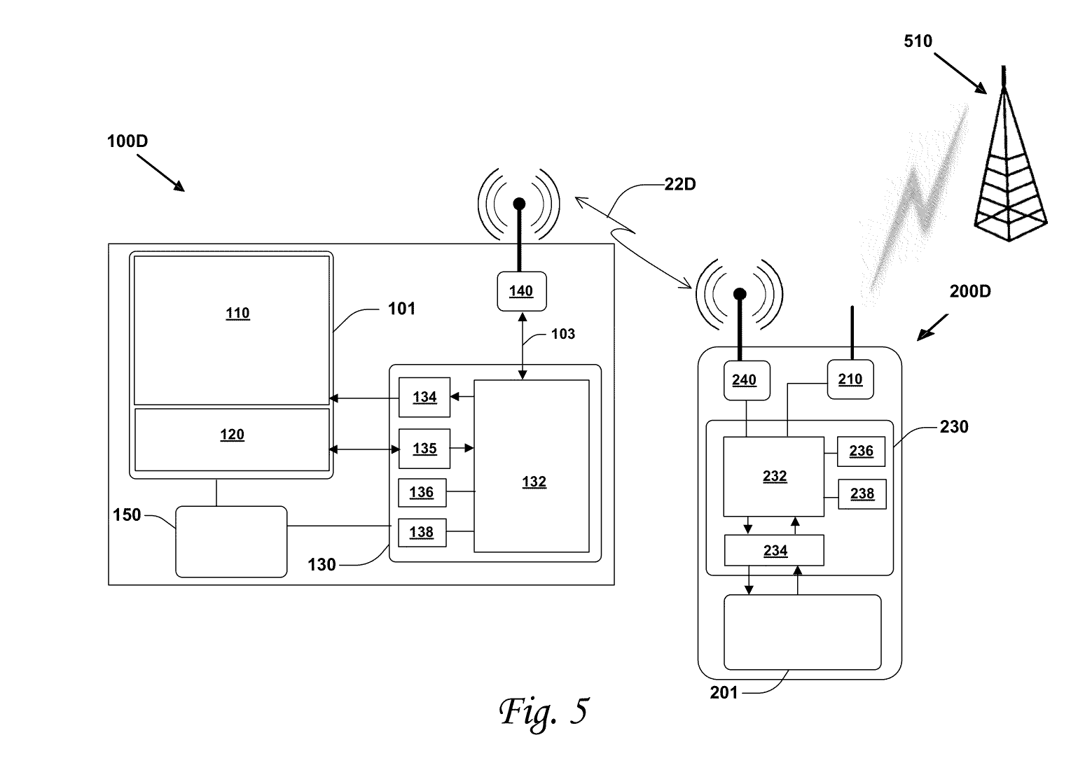

FIG. 1 is a diagram depicting an exemplary data entry and display apparatus 100 for a portable communication device 200 according certain aspects of the subject disclosure. The apparatus 100 comprises a user interface 101 that includes a display portion 110 and a data entry portion 120. In the illustrated example, the data entry portion 120 includes a keyboard 122 and a touchpad 124. As described below with respect to FIGS. 5, 6 and 8, in certain embodiments, the apparatus 100 further comprises a controller configured to engage in data communication with the portable communication device 200 via a data communication interface whereby data associated with an application executed outside the apparatus 100 can be communicated between the apparatus 100 and the device 200. In some embodiments, the application is executed in the portable communication device 200. In some embodiments, some of the tasks associated with the application is executed in an external computer (e.g., a desktop or laptop computer or server) that is remotely connected to the portable communication device 200. In certain embodiments, the application is stored and executed in an external computer (e.g., a desktop or laptop computer or server) that is remotely accessible by the device 200 using, e.g., a thin client executed in the device 200.

In operation, the data entry and display apparatus 100 sends user-entered data to the portable communication device 200 and receives data associated with the application from the device 200 using a data link 20. In some embodiments, the data received from the device 200 can include graphics data to be displayed on the display portion 110. In other embodiments, the received data includes non-graphics data for generating graphics data to be displayed in the apparatus 100.

In certain embodiments, the data link 20 is a unidirectional or bidirectional wireless data link including, but not limited to, Wi-Fi (802.11x), Bluetooth, IR data link, and Wireless USB. In some embodiments, the data link 20 is a unidirectional or bidirectional physical (wired) data link including, but not limited to, Mini USB, Micro USB, FireWire (IEEE-1394), HDMI and DisplayPort. In some embodiments, the data link 20 comprises a combination of a wireless data link and a physical data link, a combination of two or more wireless data links or a combination of two or more physical data links.

The display portion 110 is configured to display graphics associated with the application based on graphics data received from the device 200 or generated based on non-graphics data received from the device 200. The display potion 110 can be implemented using various display technologies including, but not limited to, liquid crystal display (LCD), organic light-emitting diode (OLED), electronic paper display (EDP) and interferometric modulator (IMOD) display technologies.

The data entry portion 120 is configured to allow the user to enter data by, e.g., typing on a keyboard or making a gesture on a keypad. The data entry portion 120 then generates a signal indicative of the user data entry. In certain embodiments, the data entry portion 120 is implemented using a mechanical tactile switch. In other embodiments, the data entry portion 120 is implemented using a touchscreen display device that includes display elements based on, for example, LCD, OLED, EDP or IMOD technology and touch sensing elements based on, for example, resistive, surface acoustic wave (SAW) and capacitive principles.

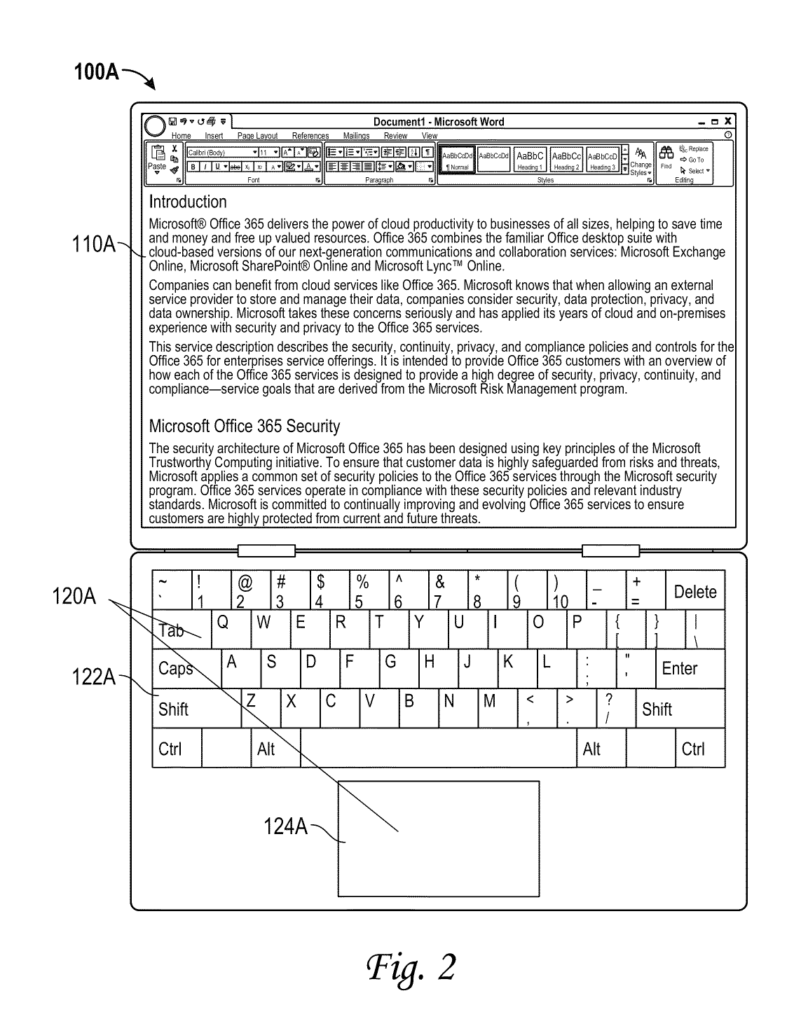

In embodiments in which the data entry portion 120 is implemented using a touchscreen display, a keyboard layout (and in some embodiments also a touch pad) can be displayed on the touchscreen display. This way, the keyboard layout can be easily changed from one keyboard layout to another depending upon the application and/or the language used. For example, FIG. 2 is a diagram depicting an exemplary data entry and display apparatus 100A displaying an English QWERTY keyboard 122A and a touchpad 124A. In the illustrated example of FIG. 2, the display portion 110A displays graphics showing English text associated with a word processing application (e.g., Microsoft Word® or a Linux word processing application).

In some embodiments, the application is executed in the portable communication device 200. In other embodiments, the application is executed at least in part in an external computer (e.g., a desktop or laptop computer or server) remotely connected to the portable communication device 200 via a network (e.g., a wireless local area network (WLAN), personal area network (PAN), a cellular network, and/or the Internet. By way of example, the user types alphanumeric characters on the QWERTY keyboard 122A displayed on the touchscreen display. Data representing the user-entered alphanumeric characters is sent to the portable communication device 200. The user-entered data is then used by the application executed in the portable communication device 200 and/or further sent to the external computer and used by the application executed in the external computer. In addition, data associated with the application (e.g., graphics data or non-graphics data to be used for generating graphics data) is sent from the device 200 to the apparatus 100. The received data is used to display graphics associated with the application in the display portion 110 of the apparatus 100.

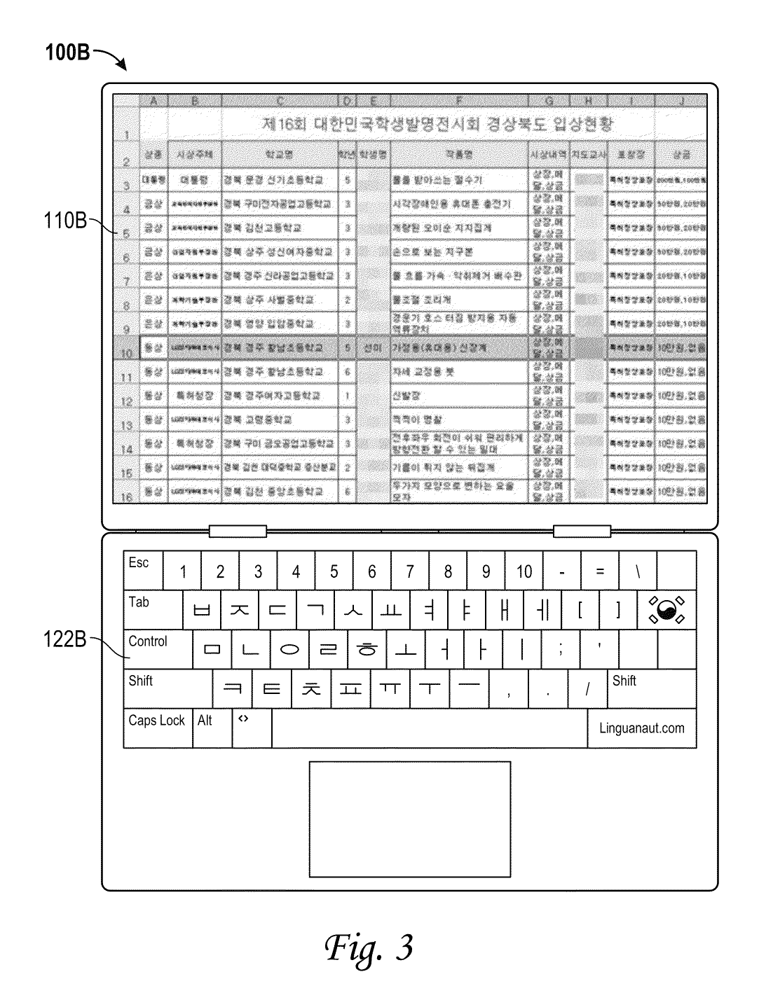

FIG. 3 is a diagram depicting an exemplary data entry and display apparatus 100B displaying a foreign-language (Korean) keyboard 122B. In the illustrated example, a display portion 110B displays graphics associated with a spreadsheet application (e.g., Microsoft Excel® or a Linux spreadsheet application) showing Korean text. The user enters Korean characters using the Korean keyboard layout 122B. Data representative of the user-entered Korean characters is sent to the portable communication device 200 to be used by the application executed in the portable communication device 200 and/or in an external computer (e.g., a desktop or laptop computer or server) remotely connected to the device 200. In addition, data associated with the application (e.g., graphics data or non-graphics data to be used for generating graphics data) is received by the apparatus 100 and used to display graphics associated with the application in the display portion 110B. Depending on the application and the language being used for the application, the keyboard layout can be switched from one language to another.

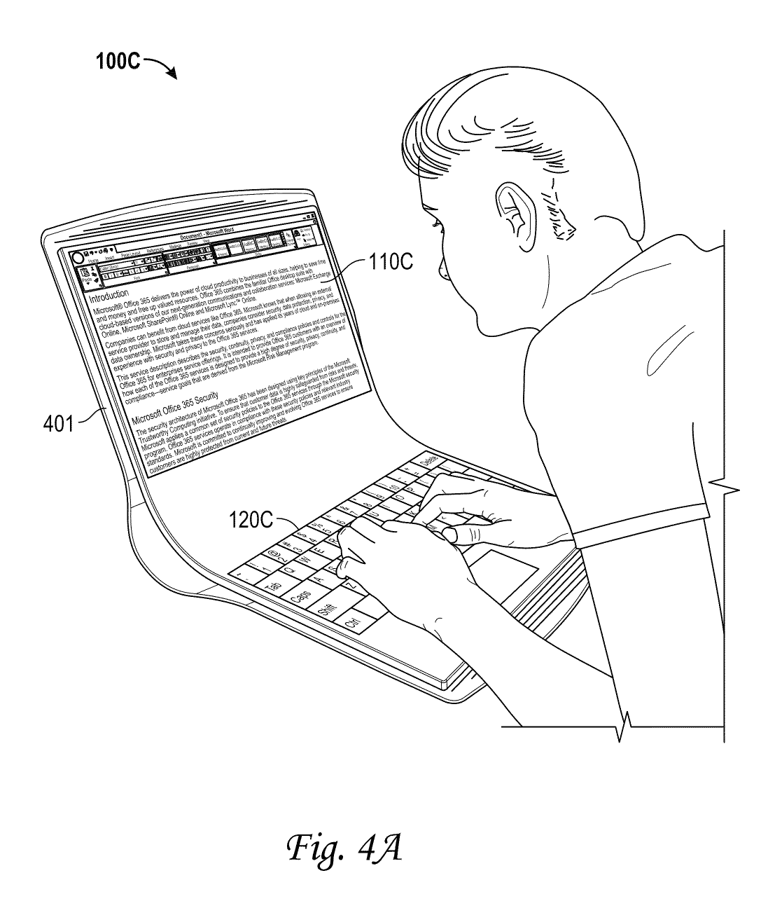

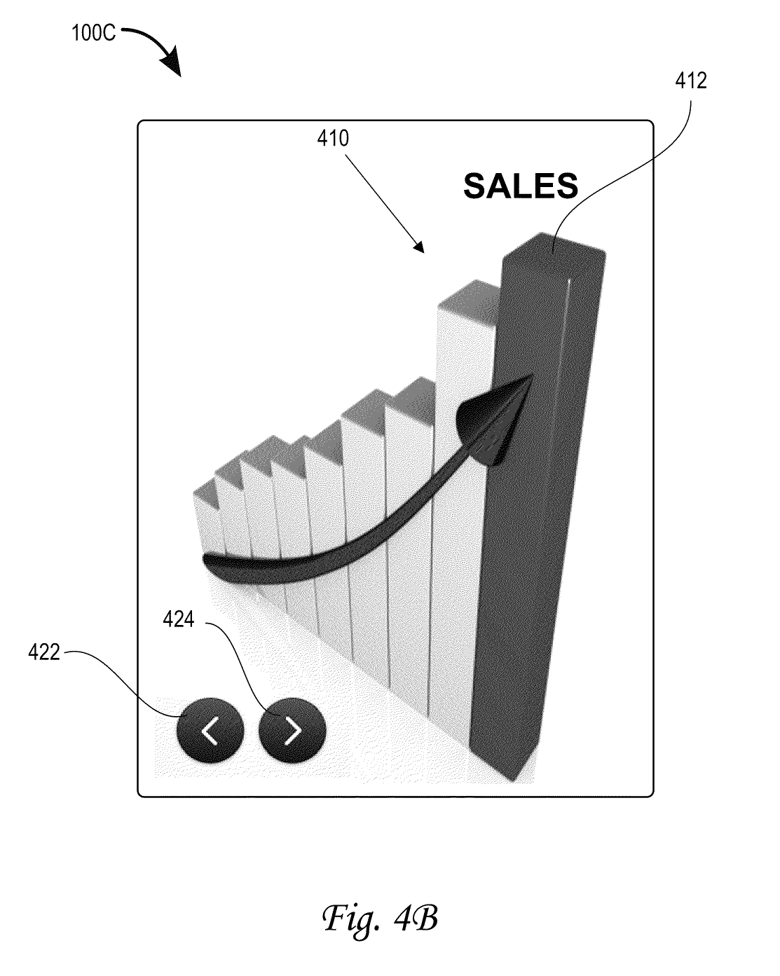

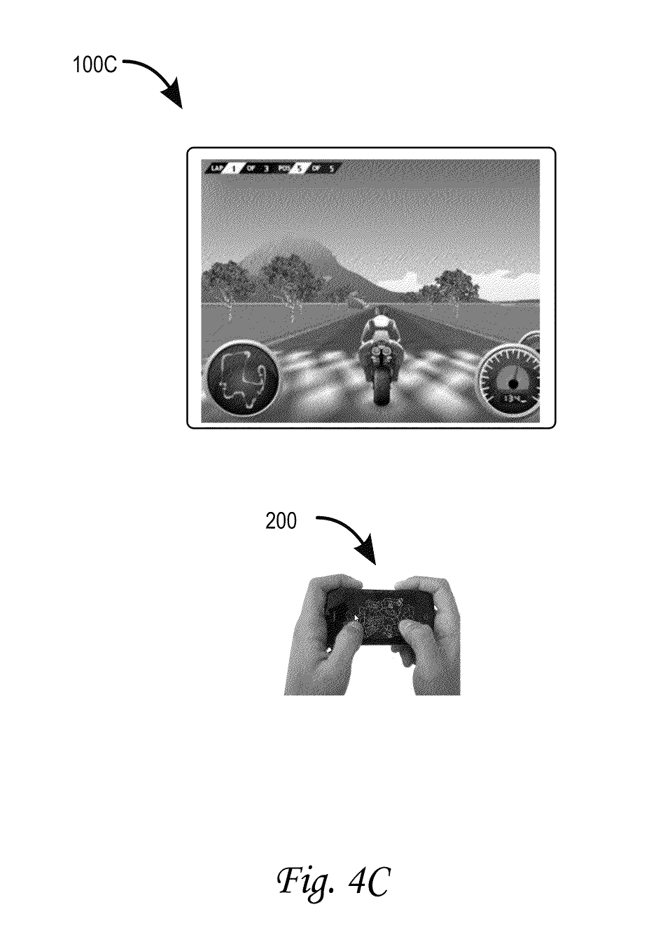

FIG. 4A is a diagram depicting an exemplary integrated data entry and display apparatus 100C according to certain aspects of the subject disclosure. In some embodiments, the integrated data entry and display apparatus 100C is a single flexible display device such as an OLED device fabricated on a flexible substrate (e.g., plastic) or an electronic paper display (EPD) device. The apparatus 100C is shown with a display portion 100C displaying a graphics mage associated with a word processing document and a data entry portion 120C displaying a keyboard layout. The apparatus 100C can be folded and carried in a folder 401 as shown in FIG. 4A or rolled and carried in a carrying tube. In some embodiments, the integrated data entry and display apparatus 100C comprises two separate but contiguously-joined display devices (e.g., LCD, OLED or IMOD devices) joined, e.g., with a hinge or other swivelable mechanism, such that when the apparatus 100C is in its a fully open position, the two display devices appear and function as a single integrated display device.

FIG. 4B is a diagram depicting the exemplary integrated data entry and display apparatus 100C of FIG. 4A in its fully open position and displaying a slide presentation. In the illustrated example, a sales bar graph 410 is displayed on the apparatus 100C. Also displayed are a left arrow button 422 and a right arrow button 424 that can be pressed by the user to move from one slide and another. In the illustrated example, the region of the touchscreen display displaying the two displayed buttons 422, 424 constitutes the data entry portion, and the region of the touchscreen display displaying the sales bar graph 410 constitutes the data display portion. In some embodiments, the data display portion and the data entry portion overlap. For instance, the user can touch an object (e.g., the last bar 412) on the bar graph 410 to either highlight the object and/or display data (e.g., sales figure) associated with the object. FIG. 4B demonstrates that the graphics image (the bar graph 410 in this example) can occupy substantially the entire touchscreen display rather than being limited to a predefined region. This arrangement can effectively double the size of the display portion as compared to the conventional laptop arrangement with separate predefined regions for data display and data entry.

By way of other examples, the user can view a movie on the integrated data entry and display apparatus 100C. In those embodiments, the touchscreen display can also display and be responsive to control buttons such as PLAY, PAUSE and QUIT buttons. The user can also play a game (e.g., an online Pictionary game) on the touchscreen display by drawing objects on the display. FIG. 4C is a diagram depicting the exemplary integrated data entry and display apparatus 100C of FIG. 4A displaying a graphics associated with a game application (e.g., a car racing game) executed in the portable communication device 200 (FIG. 1) or in an external computer remotely connected to the device 200. In the illustrated example of FIG. 4C, the device 200 (smartphone) is used as a game controller for playing the car racing game. The user can press a button or a tap displayed on the touchscreen display to move from one view (e.g., a road view) to another (e.g., an aerial view).

FIG. 5 is a diagram depicting an exemplary arrangement of a data entry and display apparatus 100D and a portable communication device 200D according to certain aspects of the subject disclosure. In the illustrated example, the apparatus 100D includes a data entry and display 101, a controller 130, a wireless interface 140, and an energy storage device 150. The data entry and display 101 includes a display portion 110 and a data entry portion 120. The controller 130 includes a processor 132, a display controller 134, a data entry controller 135, a volatile memory 136 (e.g., RAM), and a non-volatile memory 138 (e.g., ROM). In some embodiments, the display portion 110 comprises an LCD, OLED, EPD or IMOD screen, and the data entry portion 120 comprises a mechanical tactile switch (e.g., a physical keyboard). In some embodiments, the display portion 110 and the data entry portion 120 are implemented using separate display devices, with at least the data entry portion 120 having the touchscreen capabilities. In other embodiments, the display portion 110 and the data entry portion 120 are implemented in a single integrated touchscreen display device, which comprises a single flexible display device or two display devices contiguously joined as described above with respect to FIG. 4. In those embodiments in which at least the data entry portion 120 is implemented using a touchscreen display device, the data entry controller 135 includes a touchscreen controller. The energy storage device 150 can include a disposable or rechargeable battery. In some embodiments, the rechargeable battery is charged by an external power supply (not shown) via a physical (wired) connection. In other embodiments, the rechargeable battery is inductively charged from an external inductive power source (not shown).

The processor 132 of the apparatus 100D is configured to engage in a bidirectional data communication between the apparatus 100D and the device 200D. In one direction, the processor 132 receives data associated with an application from the portable communication device 200D via a wireless data link 22D. The application can be executed in the device 200D or in an external computer (e.g., a desktop or laptop computer or server) remotely connected to the device 200D. In some embodiments, one or more applications are executed in the device 200D and one or more applications are executed in the external computer. The processor 132 is further configured to provide the graphics data to the display controller 134 with or without an additional processing operation. In some embodiments, the received data includes graphics data associated with the application and the process provides the graphics data to the display controller 134. In other embodiments, the received data includes non-graphics data used by a separate program executed in the processor 132 or in other processors (e.g., a graphics processor) to generate the graphics data to be provided to the display controller 134. The display controller 134 is configured to drive (e.g., provide power and data signals to) the display portion 110D based on the graphics data provided by the processor 132, thereby causing the display portion 110D to display graphics associated with the application.

The data entry controller 135 is configured to receive signals indicative of the user data entry (e.g., keyboard presses or touchpad gestures) from the data entry portion 120D and to provide user-entered data indicative of the user data entry to the processor 132. The processor 132 is configured to transmit the user-entered data to the portable communication device 200D via the wireless data link 22D. The user-entered data is used by the application executed in the device 200D or in an external computer (e.g., a desktop or laptop computer or server) remotely connected to the device 200D.

In the illustrated example, the portable communication device 200D includes a touchscreen display 201, a controller 230, a first wireless interface 210 and a second wireless interface 240. The first wireless interface 210 can include a baseband processor for connecting the device 200D to a wireless network such as the 3G or 4G network via a base station 510 for making calls and/or sending and receiving other types of data traffic. The second wireless interface 240 includes communication chip(s) having Wi-Fi and/or Bluetooth functions, for example. The controller 230 includes an application processor 232, a touchscreen controller 234, a volatile memory 236 (e.g., RAM), and a non-volatile memory 238 (e.g., ROM or flash memory card such as MicroSD). The touchscreen controller 234 is configured to provide graphics data to the touchscreen display 201 and receive signals indicative of the user's data entry made on the touchscreen display 201 when the device 200D is used in a local data entry and display mode.

In certain embodiments, the non-volatile memory 238 is configured to store an operating system (e.g., Android, iOS, Windows Phone), various applications (preloaded or downloaded), and user data. The stored applications can include a word processing application, a spreadsheet application, a web-browser application and a game application. Some of the applications are user-configurable for either local data entry/display (i.e., on the device 200) or remote data entry/display (i.e., on the apparatus 100D). Other applications are pre-configured for remote data entry/display. Some of the applications are specially configured to run on the particular operating system (Android, iOS, Windows Phone) with the data entry and display apparatus 100D.

In certain embodiments, the processor 232 is configured to execute a remote data communication program to establish and maintain a remote data connection with the apparatus 100D such that data can be efficiently communicated between the device 200D and the apparatus 100D. In some embodiments, the remote data communication program is separate from the application for which the program establishes and maintains the remote data connection. In other embodiments, the remote data communication program is part of the application.

In certain embodiments, the processor 132 of the apparatus 100D is configured to execute a remote communication program to establish and maintain a remote data connection between the apparatus 100D and the device 200D in addition to or in lieu of the above described remote data communication program stored and executed in the device 200. For example, in certain embodiments, the processor 132 of the apparatus 100D is configured to execute a counterpart remote data communication program stored in the non-volatile memory 138 that works in concert with the above-described remote data communication program execute in the device 200D to establish and maintain the remote data connection between the device 200D and the apparatus 100D. In addition, the processor 132 executing the counterpart remote communication program receives user-entered data from the data entry controller 135 and transmits the user-entered data to the portable communication device 200D using the wireless data link 22D or any other data link provided. The processor 132 executing the counterpart remote communication program can also receive graphics data associated with the application from the portable communication device 200D and send the graphics data to the display controller 134.

In some embodiments, the counterpart remote data communication program is stored in the non-volatile memory 138. In some embodiments, some tasks associated with the application can be handled by the processor 132 of the apparatus 100D. For example, the processor 132 can generate graphics data based on non-graphics data received from the device 200D and send the generated graphics data to the display controller 134. In certain embodiments, the apparatus 100D includes a full operating system for the purpose of running the remote counterpart communication program for handling remote data connection with the device 200D and/or data transfer management programs handling data transfers between various hardware components (e.g., processor 132, display controller 134, data entry controller 135 memories 136, 138, and wireless interface 140) in the apparatus 100D. In other embodiments, the apparatus 100D merely includes a kernel for running such remote data communication and/or data transfer management programs.

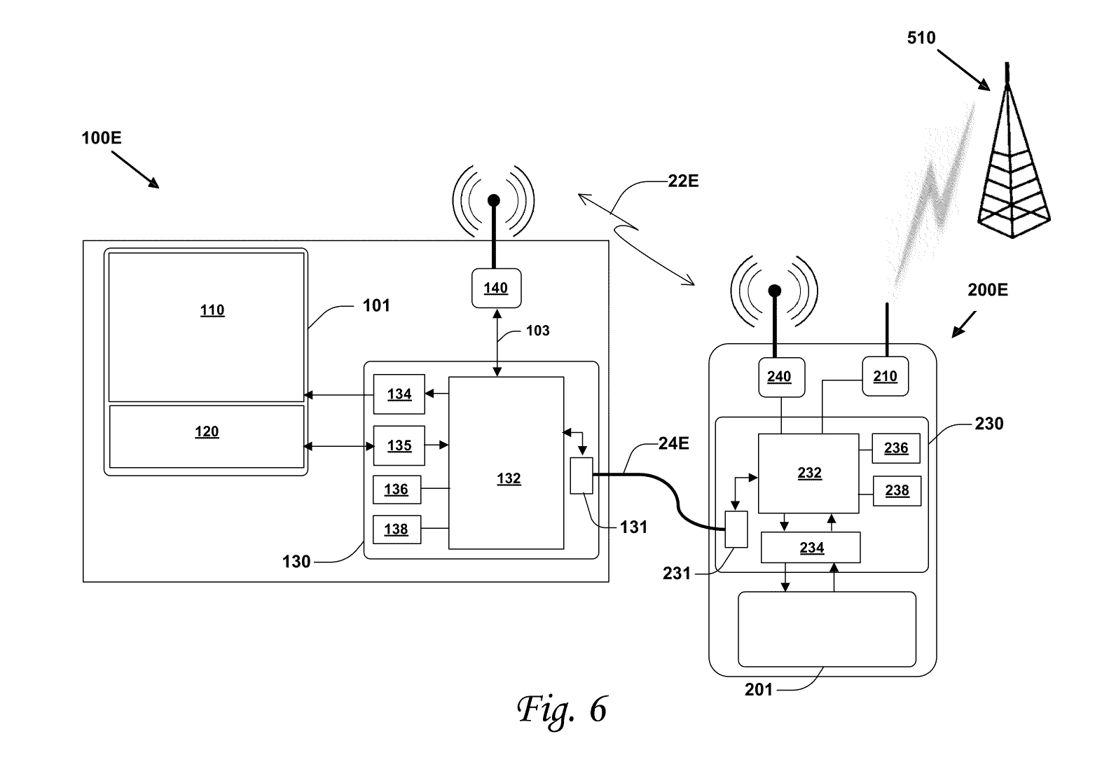

FIG. 6 is a diagram depicting another exemplary arrangement of a data entry and display apparatus 100E and a portable communication device 200E according to certain aspects of the subject disclosure. The illustrated example of FIG. 6 is substantially similar to the illustrated example of FIG. 5 except that the data link between the apparatus 100E and the device 200E includes a physical link 24E (e.g., a USB connection) in addition to or in lieu of a wireless data link 22E. In the illustrated example, the controller 230 also includes a physical data communication interface 232 (e.g., a USB transceiver) configured to provide a remote unidirectional or bidirectional data communication between the device 200E and the apparatus 100E. The controller 130 of the apparatus 100E also includes a counterpart physical data communication interface 131 (e.g., a USB transceiver) that sends and receives data to and from the physical data communication interface 232 in the controller 230 of the device 200E. In the illustrated example, the physical link 24E includes a cable (e.g., a USB cable) connecting the apparatus 100E and the device 200E. In some embodiments, the cable is retractably extendable from the apparatus 100E or the device 200E. In other embodiments (not shown), the physical link 24E is implemented using a direct plug-in socket connection between the apparatus 100E and the device 200E.

Various data link arrangements are possible. In certain embodiments, bidirectional data links (i.e., a data link from the device 200E to the apparatus 100E and a data link from the apparatus 100E to the device 200E) are implemented using the physical link 24E utilizing, for example, a USB (e.g., USB 3.0) interface. In some embodiments, the data link carrying graphics data from the device 200E to the apparatus 100E is implemented using a HDMI or DisplayPort connection, while the data link carrying user-entered data from the apparatus 100E to the device 200E is implemented using a USB connection. In some embodiments, the physical data communication interface includes a HDMI or DisplayPort controller in addition to a USB transceiver.

In some embodiments, one of the bidirectional data links is implemented using the physical link 24E (e.g., USB, HDMI or Display Port) and the other of the bidirectional data links is implemented using the wireless link 22E (e.g., Wi-Fi, Bluetooth, Wireless USB). For example, it may be advantageous to use the physical link 24E to send the higher data-rate graphics data from the device 200E to the apparatus 100E while using the wireless link 22E to communicate the lower data-rate user-entered data from the apparatus 100E to the device 200E. In some embodiments, the physical link 24E (e.g., USB) also provides power from the device 200E to the apparatus 100E, thereby eliminating or reducing the requirements for an energy storage in the apparatus 100E.

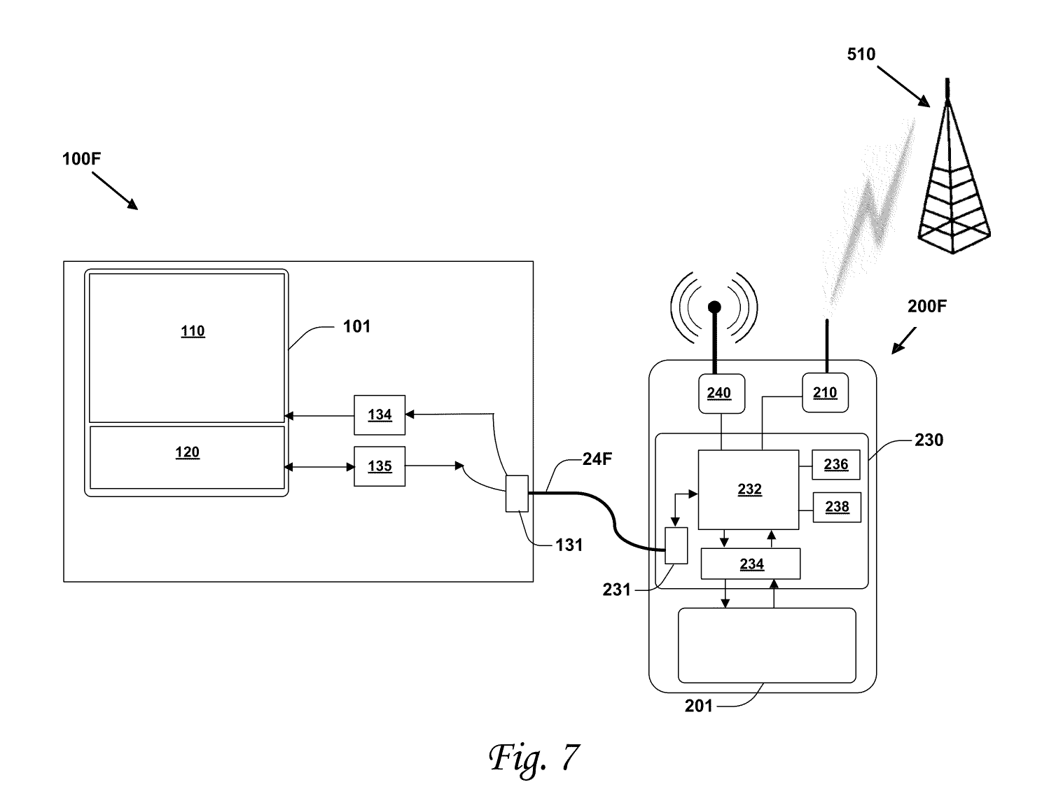

FIG. 7 is a diagram depicting of another exemplary arrangement of a data entry and display apparatus 100F and a portable communication device 200F according to certain aspects of the subject disclosure. In the illustrated example of FIG. 7, the apparatus 100F does not include a processor for controlling the remote data connection (e.g., receiving and sending data) between the apparatus 100F and the device 200F and/or performing additional processing on the received data. Instead, the display controller 134 receives graphics data directly from the device 200F via a physical link 24F or a wireless link (not shown) and the data entry controller 135 sends user-entered data directly to the device 200F via the physical link 24F or a wireless link. In the illustrated example, the controller 230 also includes a physical data communication interface 231 (e.g., a USB transceiver and/or a HDMI transceiver) configured to provide unidirectional or bidirectional remote data connection between the processor 232 of the device 200F and the display controller 134 and/or the data entry controller 135 of the apparatus 100F.

In the illustrated example of FIG. 7, the apparatus 100F also includes a counterpart physical data communication interface 131 (e.g., USB and/or HDMI transceiver/controller) for sending and receiving data to and from the corresponding data communication interface 231 in the device 200F. In some embodiments, the physical data communication interface includes a HDMI or DisplayPort controller in addition to or in lieu of a USB transceiver for sending high-resolution graphics data. In certain embodiments, the display controller 134 or the display portion 110 has a built-in data communication interface that can receive graphics data directly from the device 200F. For example, in some embodiments, the display controller 134 includes a corresponding HDMI or DisplayPort functionality for receiving HDMI- or DisplayPort-compliant data. In other embodiments, the display portion 110 includes a built-in HDMI or DisplayPort transceiver/controller. In these embodiments, the separate physical data communication interface 131 may be eliminated.

Significant reductions in cost, design complexity and power consumption can be achieved by eliminating the need for a processor for establishing and managing remote data connection and associated memories in the apparatus 100F. In certain embodiments, a further reduction in power consumption can be achieved by employing an energy-efficient display such as an IMOD display or EPD that draws littler or no power while displaying a static image. In some embodiments, the display portion 120 for displaying a keyboard layout is implemented using a touchscreen-enabled IMOD display as the displayed keyboard layout does not require a frequent change. One or more of these and other power-reducing arrangements enable the apparatus 100F to be powered from a small-capacity rechargeable or disposable battery or directly from the device 200F via the physical connection 24F, thereby achieving associated reductions in cost and weight of the apparatus 100F and also eliminating the need to carry and physically connect an external power supply. In those embodiments provided with a small-capacity rechargeable battery, the battery can be inductively charged with an external inductive power source.

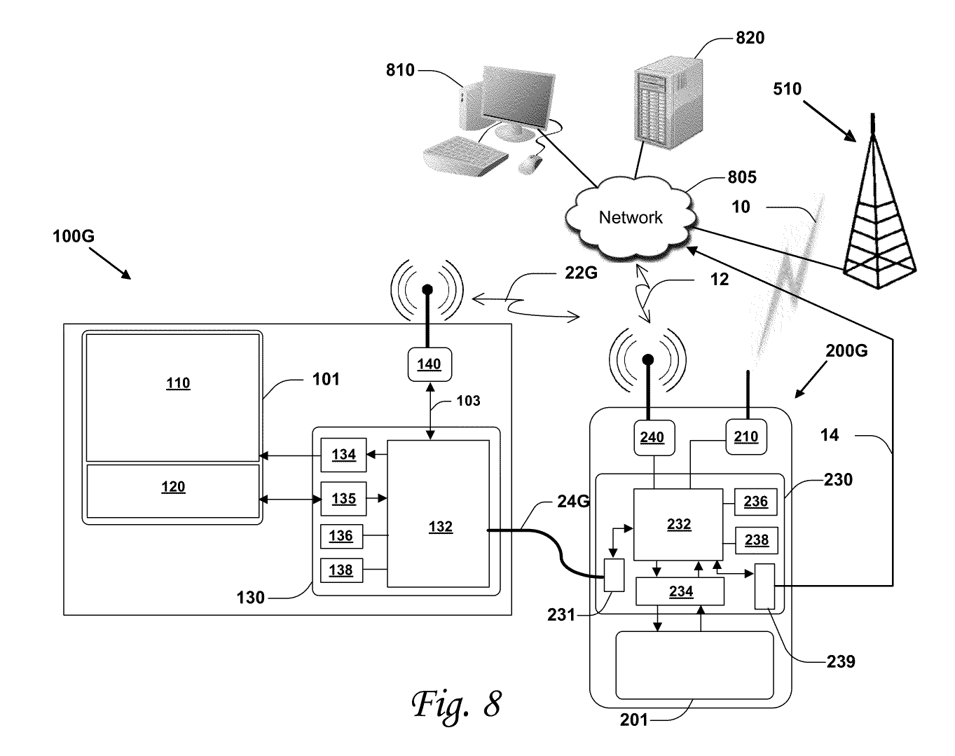

FIG. 8 is a diagram depicting another exemplary arrangement of a data entry and display apparatus 100G and a portable communication device 200G according to certain aspects of the subject disclosure. In the illustrated example, the portable communication device 200G is remotely connected to an external computer (e.g., a desktop computer 810 or a server 820) via a network 805. The external computer 810, 820 can be in the user's residence, company or any other premises (e.g., hotel, restaurant, coffee shop, car, airplane, and school). In certain embodiments, the remote connection is made via a first wireless connection 10 using, e.g., a cellular network or via a second wireless connection 12 using, e.g., a Wi-Fi network (infrastructure or ad-hoc). In some embodiments, the remote connection can be made via a physical connection 14. The physical connection 14 can include a wired local area network such as an Ethernet network. In some embodiments, the device 200G can include a separate physical data communication interface 239 such as a USB 2.0 or 3.0 transceiver or an Ethernet transceiver for sending and receiving data via the physical connection 14.

In certain embodiments, the application to be displayed in the apparatus 100G is stored in the device 200G. In some embodiments, at least some of the tasks associated with the application stored in the device 200G are performed in the external computer 810, 820. For example, certain computing-intensive tasks associated with the application are outsourced to the external computer/server 810, 820. Examples of augmented execution of smartphone applications are described in “Augmented Smartphone Application Through Clone Cloud Execution” by Byung-Gon Chun and Petros Maniatis, which is incorporated by reference herein for all purposes. By way of example, assume that a CAD application is stored and executed at least in part in the portable communication device 200G (e.g. a smartphone). The device 200G is also remotely connected to the external computer 810, 820 via the network 805. If the processor 232 in the device 200G is not capable of handling certain computing-intensive tasks (e.g., generation of a 3-D model), the computing-intensive tasks are outsourced to the external computer 810, 820. A processor in the computer 810, 820 executes the computing-intensive tasks and sends the results (e.g., graphics data representing the 3-D model) to the device 200G. Graphics data associated with the 3-D model is then sent to the apparatus 100G to be displayed in the display portion 110 of the apparatus 100G.

In some embodiments, an application is “hosted” or stored and executed in the external computer 810, 820 and remotely accessed by the device 200G using a thin client application, e.g., a mobile-client software, that is capable of streaming graphics data associated with the application and/or the virtual desktop to the device 200G. In such embodiments, the device 200G sends the graphics data and/or the virtual desktop to the apparatus 100G. The device 200G can also receive user-entered data from the apparatus 100G and send the user-entered data to the external computer 810, 820 hosting the application. In some embodiments, one or more applications are executed in the device 200E and one or more applications are executed in the external computer 810, 820.

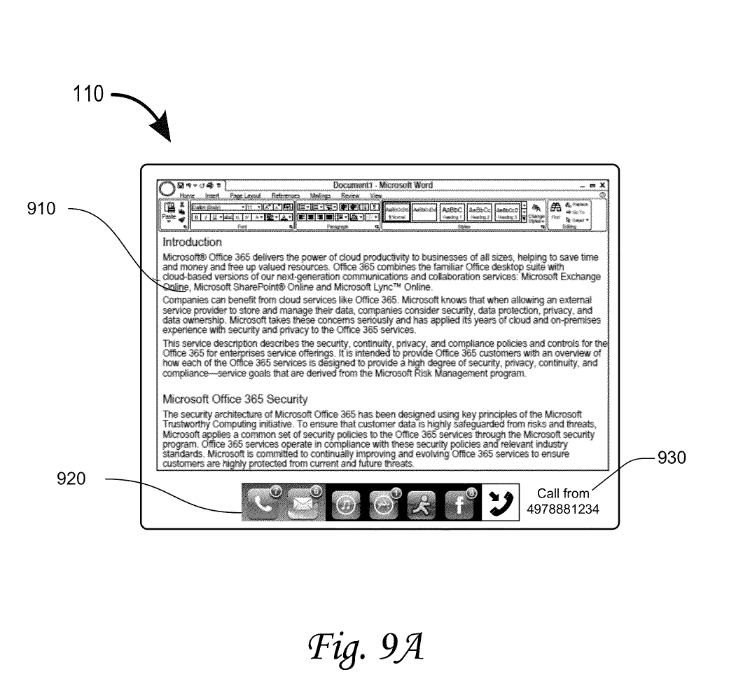

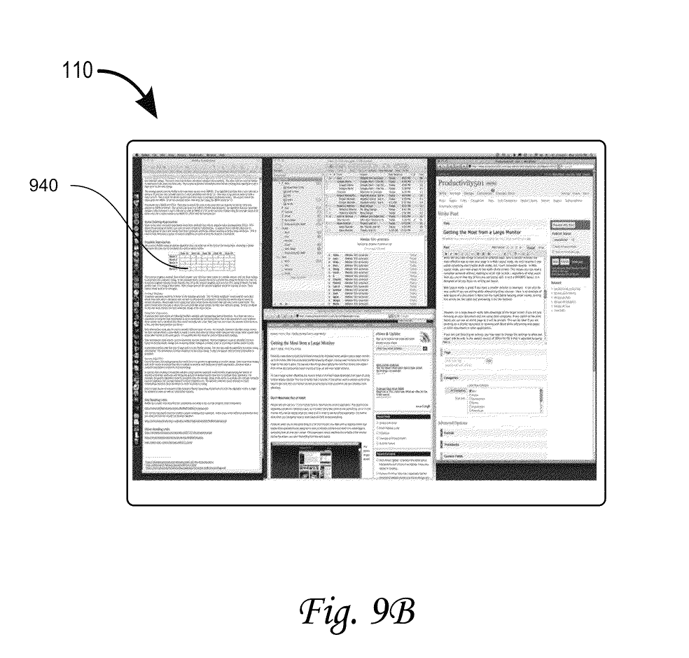

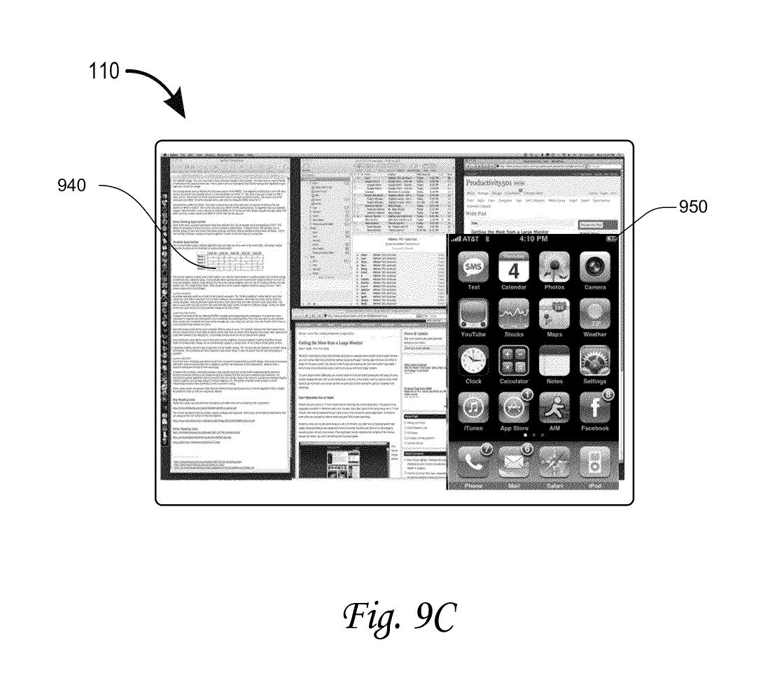

In certain embodiments, the apparatus 100E can display the user interface of the device 200E or one or more objects from the user interface. For example, the user can view the home screen of his smartphone on the display portion 110 and click on an icon on the home screen to launch an application executed in the smartphone and/or in the external computer 810, 820. In some embodiments, as illustrated in FIG. 9A, the display portion 110 of the apparatus 100E can display notification objects 920 for e-mail, voice mail, electronic message (e.g., sms, mms, instant messenger) and incoming call, along with an application 910 (executed in the device 200E or in the external computer 810, 820) that the user is working on, to notify him of a new e-mail, message or call received by the smartphone. The display portion 110 can also display a source 930 (e.g., caller ID) of the e-mail, message or call. In some embodiments, the device 200E is configured to generate and send combined graphics data representing the application 910 and the notification objects 920, 930 to the apparatus 100E.

In certain embodiments, as illustrated in FIG. 9B, the display portion 110 of the apparatus 100E can display multiple windows associated with multiple applications executed in the device 200E and/or the external computer 810, 820. For example, the display portion 110 can display a virtual or remote desktop 940 with multiple windows associated with a plurality of applications sent from the external computer 810, 820. In some embodiments, as illustrated in FIG. 9C, a display portion 110 can display the virtual/remote desktop 940 displaying the multiple windows along with the device's user interface 950 (e.g., a home screen) displayed in another window. In some embodiments, the device 200E is configured to generate and send combined graphics data representing the virtual desktop and the user interface to the apparatus 100E.

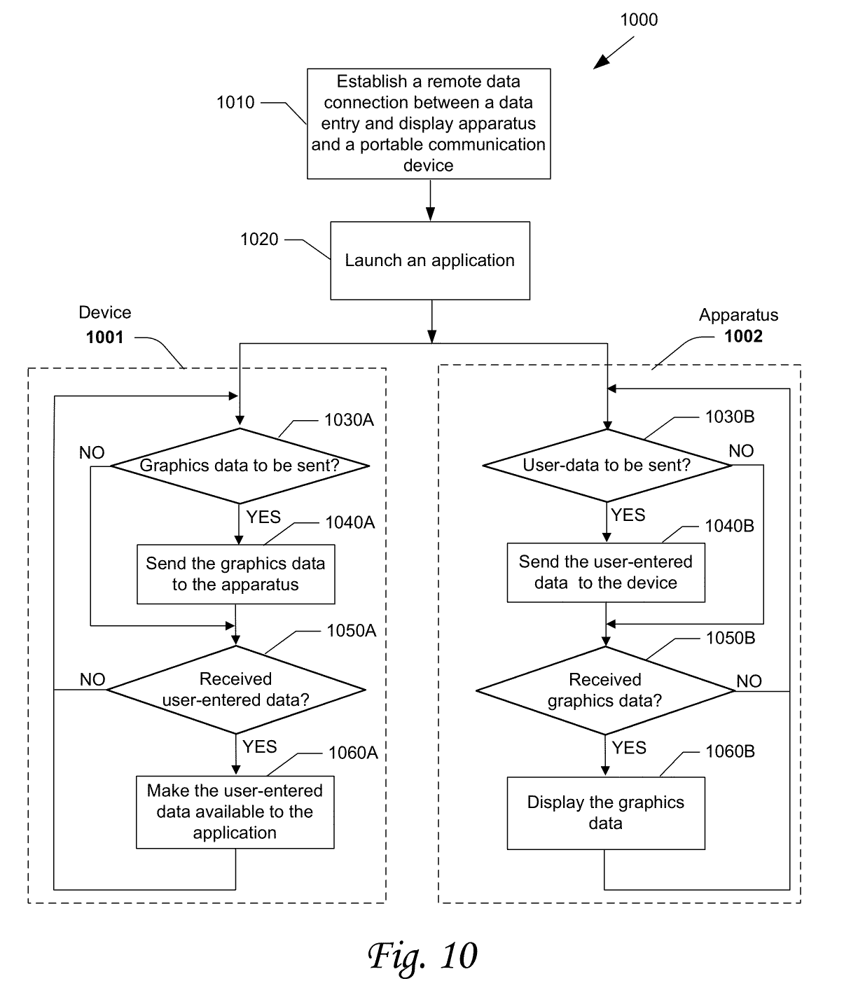

FIG. 10 is a flowchart illustrating an exemplary process 1000 for operation of a data entry and display apparatus and a portable communication device according to certain aspects of the subject disclosure. For ease of illustration, without any intent to limit the scope of the subject disclosure in any way, the process 1000 will be described with references to one or more exemplary embodiments described above. The process 1000 starts at operation 1010 in which a remote data connection is established between a data entry and display apparatus and a portable communication device.

In certain embodiments, the remote data connection is established using a remote data communication program stored and executed in the device. As described above, the remote data communication program can be either separate from or part of the application to be remotely connected to the apparatus. In some embodiments, a counterpart remote data communication program is stored and executed in the apparatus that cooperates with the remote data communication program stored and executed in the device. A processor (232, 132) in the initiating device (e.g., device 200E or apparatus 100E) sends a signal requesting a remote data connection to a processor in the receiving device (e.g., apparatus 100E or device 200E). In some embodiments, the signal includes a unique identity data associated with the initiating device, causing the processor in the receiving device to verify the identity data and, upon successful verification, send an acknowledgment to the initiating device. In some embodiments, after the remote data connection between the device and the apparatus is established, the device's user interface (e.g., smartphone's home screen) is displayed on the apparatus.

In certain embodiments, the remote data communication program running in the portable communication device 200E is automatically launched when the device 200E is turned on and runs in the background. The remote data communication program searches for a data entry and display apparatus. When the device 200E finds the apparatus 100E, for example, by detecting a signal sent from the apparatus 100E via the wireless data interface 140 or the physical data interface 131, the program establishes a remote data connection with the apparatus 100E. In some embodiments, a remote data communication program running in the apparatus 100E searches for a portable communication device, and, upon detecting a signal from the device 200E, establishes a remote data connection with the device 200E. Data associated with any application subsequently launched in the device 200E or the external computer 810, 820 (FIG. 8) can be communicated to and from the apparatus 100E using the pre-established remote data connection.

In those embodiments in which an application to be remotely connected to the apparatus is executed at least in part in the external computer 810, 820 (FIG. 8), a second remote data connection between the device 200G and the external computer 810, 820 is established so that user-entered data and data associated with the application can be communicated between the apparatus 200G and the external computer 810, 820 via the device 200G using the remote data connection between the device and the apparatus and the second remote data connection between the device and the external computer 810, 820. In some embodiments, the device's user interface displayed on the apparatus (e.g., FIG. 9C) can include an icon for the external computer 810, 820 and the user can establish the second remote data connection by double-clicking the icon for the external computer 810, 82, thereby causing the external computer 810, 820 to stream a remote desktop to the apparatus via the device 200G. In some embodiments, the remote data connection between the device and the apparatus and the second remote data connection between the device and the external computer are established automatically.

The process 1000 proceeds to operation 1020 in which an application to be remotely connected to the apparatus for data entry and display purposes is launched. In certain embodiments, the application is launched from the apparatus by double-clicking an icon for the application displayed on apparatus. In some embodiments, the icon for the application appears in the device's user interface or the remote desktop displayed on the apparatus. As a result of the launching, the application is executed in the portable communication device or in an external device (e.g., a corporate computer/server 810, 820 (FIG. 8)) remotely connected to the device. In the former case, a signal indicative of the application to be launched is communicated from the apparatus to the device, and the device launches the application stored in the device. In the latter case, the device sends a signal indicative of the application to be launched to the external device causing the external device to launch the application. In some alternative embodiments, the application is launched from the portable communication device instead of the data entry and display apparatus. After the application is launched, the process 1000 proceeds to two separate processes, a first (left) process 1001 in the portable communication device 200E and a second (right) process 1002 in the data entry and display apparatus 100E.

In the device 200E, the first process 1001 starts at query state 1030A in which it is determined whether there is any data (e.g., graphics data or data for generating graphics data) to be sent from the device 200E to the apparatus 100E. For example, the processor 232 in the device 200E may continuously or periodically monitor a memory location reserved for graphics data to determine if there is new or updated graphics data to be sent to the apparatus 100E. Alternatively, the remote data communication program receives new or updated graphics data or a signal indicative of new or updated graphics data from the application. If the answer to the query is No (no graphics data to be sent), the process 1001 jumps to query state 1050A which is described below.

On the other hand, if the answer to the query is YES (graphics data to be sent), the process 1001 proceeds to operation 1040A in which the graphics data (or data for generating graphics data) is sent from the device to the apparatus In some embodiments, the processor 232 in the device 200E performs additional processing operations (e.g., formatting, packetizing, framing, compression and/or encryption) on the graphics data before the data is sent to the apparatus 100E. As described above with respect to FIG. 6, data can be sent from the device 200E to the apparatus 100E using either the wireless data link 22E based on, for example, a Wi-Fi or Bluetooth connection or the physical data link 24E based on, for example, USB, HDMI or DisplayPort connection. In some embodiments, as described above with respect to FIG. 7, a direct data link can be established without involving a communication processor in the apparatus 100F. In such an arrangement, the display controller 134 or the display portion 110 in the apparatus 100F receives graphics data directly from the device 200F via the physical link 24F using, for example, a USB, HDMI or DlsplayPort connection.

The process 1001 proceeds to query state 1050A in which it is determined whether user-entered data is received from the apparatus. If the answer to the query is NO, the process 1001 loops back to the query state 1030A to determine whether there is any graphics data to be sent. On the other hand, if the answer to the query is YES (user-entered data received), the process 1001 proceeds to operation 1060 in which the received user-entered data is made available to the application executed in the device 200E or in an external computer 810, 820 (FIG. 8) remotely connected to the device 200G.

For example, when the user types an alphanumeric character in the data entry portion 120 of the apparatus 100E, data representative of the character (e.g., an ASCII code) is sent to the device 200E The processor 232 of the device 200E receives the user-entered character data and makes the data available to a word processing or spreadsheet application executed in the device 200E, for example, by writing the character data to a specific memory location (e.g., in the volatile memory 236) reserved for user-entered data. By way of another example, when the user makes a gesture (e.g., moving, single- or double-tapping, scrolling, resizing and dragging) on the touchpad 124 (FIG. 1), data representative of the gesture is sent to the device 200E and is made available to the application in a similar fashion. In the illustrated embodiment of FIG. 8 in which all or some of the tasks associated with the application are executed in the external computer 810, 820, the processor 232 of the device 200G causes the received user-entered data to be sent to the external computer 810, 820 using the first or second wireless connection 10, 12 (e.g., 4G or Wi-Fi connection) or the physical connection (e.g., socket or Ethernet connection) or any other remote data connection available between the device 200G and the external computer 810, 820. After the user-entered data is made available to the application, the process 1001 loops back to the query state 1030A.

In the apparatus 100E, the second process 1002 starts at query state 1030B in which it is determined whether there is any user-entered data to be sent to the device 200E. As described above, the user-entered data can be representative of, e.g., alphanumeric characters or gestures. If the answer to the query is NO (no user-entered data to be sent), the process 1002 jumps to query state 1050B to be described below. On the other hand, if the answer to the query is YES (user-entered data to be sent), the process 1002 proceeds to operation 1040B in which the user-entered data is sent to the device using a physical or wireless data link. For example, when the user enters data by pressing a key on the keyboard 122 (FIG. 1) or making a gesture (e.g., moving, resizing, single- or double-tapping, scrolling and dragging) on the touchpad 124 (FIG. 1), the processor 132 receives data corresponding to the user data entry from the data entry controller 135 and sends the user-entered data (e.g., an ASCII code) to the device 200E (FIG. 6) via the wireless data link 22E or the physical data link 24E. In the exemplary embodiment of FIG. 7, the user-entered data from the data entry controller 135 is sent directly to the device 200F via the physical link 24F or a wireless link (not shown). The user-entered data sent by the apparatus is received and made available to the application by the device as described above with respect to the process 1001.

The process 1002 proceeds to query state 1050B in which it is determined whether graphics data (or data to be used for generating graphics data) is received from the device. If the answer to the query is NO, the process 1002 loops back to the query state 1030B to determine whether there is any user-entered data to be sent. On the other hand, if the answer to the query is YES (received graphics data or data for generating graphics data), the process 1002 proceeds to operation 1060B in which the received graphics data is displayed or the received data is used for generating the graphics data which is then displayed.

For example, the processor 132 in the apparatus 100E receives the graphics data from the device 200E and sends the received graphics data to the display controller 134. In certain embodiments, the processor 132 directly sends the graphics data to the display controller 134. In other embodiments, the processor 132 writes the graphics data to a memory location (in, e.g., the volatile memory 136) and the display controller 134 retrieves the graphics data from the memory location. In some embodiments, the processor 132 performs additional processing operations (e.g., reformatting, decompression and/or decryption) on the graphics data before sending the data to the display controller 134. The display controller 134, after receiving the graphic data, updates or changes what is displayed on the display portion 110 based on the received graphics data. In the illustrated embodiment of FIG. 7, the received graphics data is sent directly to the display controller 134 or the display portion 110 without involving a separate processor. After the graphics data is displayed at the apparatus, the process 1002 loops back to the query state 1030B.

The description of various embodiments are provided to enable any person skilled in the art to practice the various embodiments described herein. While the subject disclosure has been particularly described with reference to the various figures and embodiments, it should be understood that these are for illustration purposes only and should not be taken as limiting the scope of the subject disclosure. Various modifications, additions, deletions or changes in the order of operations can be made without departing from the scope of the subject disclosure.

Execution of the sequences of instructions contained in the memory causes the processor 132, 232 perform the process steps described herein. One or more processors in a multi-processing arrangement may also be employed to execute the sequences of instructions contained in memory. In alternative embodiments, hard-wired circuitry may be used in place of or in combination with software instructions to implement various embodiments. Thus, embodiments are not limited to any specific combination of hardware circuitry and software.

A reference to an element in the singular is not intended to mean “one and only one” unless specifically stated, but rather “one or more.” The term “some” refers to one or more. The term “include” and “comprise,” as well as derivatives thereof, mean inclusion without limitation; the term “or,” is inclusive, meaning and/or; the phrase “associated with,” as well as derivative thereof, may mean to generate or be generated by, provide or be provided by, include, be included within, interconnect with, contain, be contained within, connect to or with, couple to or with, be communicable with, cooperate with, interleave, juxtapose, be proximate to, be bound to with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. All structural and functional equivalents to the elements of the various embodiments of the invention described throughout this disclosure that are known or later come to be known to those of ordinary skill in the art are expressly incorporated herein by reference and intended to be encompassed by the invention. Moreover, nothing disclosed herein is intended to be dedicated to the public regardless of whether such disclosure is explicitly recited in the above description.

1. A data entry and display apparatus for a portable communication device, the apparatus comprising:
a data entry portion configured to receive a user data entry for use by an application executed outside the apparatus;
a display portion configured to display graphics associated with the application; and
a data communication interface configured to receive data associated with the application from the portable communication device and to send user-entered data indicative of the user data entry to the portable communication device using one or more data links.

2. The apparatus of claim 1, wherein the data entry portion comprises a touchscreen display device.

3. The apparatus of claim 2, wherein the data entry portion comprises an image displayed on the touchscreen display device for the user data entry.

4. The apparatus of claim 1, wherein the data entry portion and the display portion are implemented in two contiguously-joined display devices, further wherein at least the data entry portion is a touchscreen display device.

5. The apparatus of claim 2, wherein the data entry portion and the display portion are implemented in a single integrated touchscreen display device.

6. The apparatus of claim 5, wherein the touchscreen display device comprises an organic light-emitting diode (OLED) device fabricated on a flexible substrate.

7. The apparatus of claim 1, wherein the application is executed in the portable communication device.

8. The apparatus of claim 7, wherein the display portion is configured to display a user interface of the portable communication device.

9. The apparatus of claim 8, wherein the application is launched from the user interface display on the display portion.

10. The apparatus of claim 9, wherein at least one task associated with the application is executed in an external computer remotely connected to the portable communication device.

11. The apparatus of claim 1, wherein the application is executed in an external computer remotely connected to the portable communication device.

12. The apparatus of claim 11, wherein the display portion is configured to display a remote desktop sent from the external computer.

13. The apparatus of claim 12, wherein the application is launched from the remote desk top displayed on the display portion.

14. The apparatus of claim 1, wherein the user-entered data comprises data indicative of gestures.

15. The apparatus of claim 1 further comprising a processor connected to the data communication interface and a display controller connected to the display portion, wherein the processor is configured to receive the data associated with the application from the data communication interface and to provide the data associated with the application to the display controller.

16. The apparatus of claim 1, wherein the data communication interface is connected to a display controller connected to the display portion and configured to receive graphics data associated with the application from the portable communication device and provide the graphics data to the display controller.

17. The apparatus of claim 1, wherein the one or more data links comprise a physical link and further wherein the apparatus is powered from the physical link.

18. A portable communication device comprising:
a first data communication interface configured to provide a first remote data connection with an external computer configured to execute an application;
a second data communication interface configured to provide a second remote data connection with an external data entry and display apparatus configured to display graphics associated the application and generate user-entered data to be used by the application; and
a processor configured to receive the user-entered data from the apparatus via the second data communication interface and provide the user-entered data to the external computer via the first data communication interface.

19. The device of claim 18, wherein the processor is further configured to receive data associated with the application from the external computer via the first data communication interface and send graphics data associated with the application to the apparatus via the second data communication interface.

20. The device of claim 19, wherein the graphics data comprises a remote desktop sent from the external computer.

21. A portable communication device comprising:
a memory for storing an application;
a first data communication interface configured to provide a first remote data connection with an external computer configured to execute at least one task associated with the application;
a second data communication interface configured to provide a second remote data connection with an external data entry and display apparatus configured to display graphics associated with the application and generate user-entered data to be used by the application; and
a processor configured to execute the application and to receive a result of the at least one task executed in the external computer via the first data communication interface and to send data associated with the application to the apparatus via the second data communication interface.

22. The device of claim 21, wherein the processor is further configured to receive the user-entered data from the apparatus via the second data communication interface and send the user-entered data to the external computer via the first data communication interface.
